(19) United States
(12) Patent Application Publication
(10) Pub. No.: US 2005/0186952 A1
(43) Pub. Date: Aug. 25, 2005

(54) Wireless communication system and a firmware update method of a wireless communication terminal station in the same

(75) Inventor: Tasuku Kitajima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/059,367

(22) Filed: Feb. 17, 2005

(30) Foreign Application Priority Data
Feb. 20, 2004 (JP) 045117/2004

(51) Int. Cl. H04B 1/38; H04M 1/00; H04M 3/00

(52) U.S. Cl. 455/419; 455/418

(57) ABSTRACT

In a wireless communication system and a firmware update method of a wireless communication terminal station in the system, firmware can be safely downloaded and updated through wireless communication without affecting user's ordinary data communication. The CPU executes arithmetic control processing for various types of data. For example, the CPU controls the data conversion achieved by an high-layer interface. Specifically, to send data from the wireless LAN card to the mobile terminal, the CPU controls conversion processing for the high layer. Conversely, when the mobile terminal sends data to the wireless LAN card, the CPU controls the conversion for the low layer. The CPU also reads and executes a firmware program recorded in one of the memories. The CPU refers to the boot information memory and determines from which one of the memories the firmware is to be read. At firmware update, the CPU determines in which one of the memories data is to be written.

### BACKGROUND OF THE INVENTION

1. Field of the Invention

The present invention relates to a wireless communication system and a firmware update method of a wireless communication terminal station in the same, and in particular, to a wireless communication system and a firmware update method of a wireless communication terminal station in the same in which download and update of firmware can be conducted through wireless communication without affecting user's data communication.

2. Description of the Prior Art

Recently, portable information processing terminals such as a personal computer and a personal digital assistant (PDA) have been broadly develop and internet communication lines are increasingly used a broadband systems. Therefore, a demand for a wireless local-area network (LAN) capable of high-speed data communication indoors as well as outdoors has been increasing. To communicate data via a wireless LAN, a wireless communication terminal station such as a wireless LAN card is installed in an information processing terminal, the terminal is placed in a range of a base station such as a wireless LAN access point and is connected to a data communication network outside the range such as an internet communication network to thereby carry out data communication.

In general, the wireless communication terminal station operates according to firmware incorporated therein. The firmware is installed in the terminal before shipment by a manufacturing vendor of wireless communication terminal stations and is supplied to the user.

The firmware is often updated, for example, due to faults thereof, and hence updated firmware is provided to the user depending on cases.

In a first firmware update method of the prior art, a recording medium, for example, a compact disk recordable (CD-R) having recorded the update firmware is supplied to the user. The user reads the update firmware from the recording medium by a reader's device of, for example, a personal computer (PC). The PC updates the firmware of a wireless communication terminal station mounted thereon.

According to a second firmware update method of the prior art, the user accesses from, for example, his or her PC or the like a firmware download site provided by the manufacturing vendor to download the firmware. The personal computer updates the firmware in response to an indication from the user.

In these methods, the user supplies an update indication to the personal computer to update the firmware.

In a third firmware update method, when the wireless communication terminal station installed in the personal computer of the user is connected to a base station, the terminal station accesses the download site through wireless communication to download the firmware to thereby update the firmware. When this method is adopted, the user cannot perceive or recognize the download and the update of the firmware.

Specifically, in the third method, after the update firmware is stored in a buffer memory of the terminal station, a firmware update program is executed to access each firmware section to be updated and then updates the section using the update firmware stored in the buffer memory.

During the download of the update firmware, the firmware is subdivided into blocks of a predetermined size to intermittently download the respective blocks. Using the period of time between the download operations, the user can communicate target data, for example, pieces of e-mail and browse web sites.

Techniques regarding the firmware update method of the wireless communication terminal station include, for example, a technique regarding a software update method using wireless communication. Specifically, there has been introduced a software update method and a software update device for a wireless communication terminal or a wireless terminal in a mobile communication system in which a base station is connected to a plurality of wireless terminals through wireless communication lines.

According to the technique, each wireless terminal notifies version information of control software used for operation thereof to a software supply device connected to the network side. Having received the version information, the software supply device compares the information with latest version information stored in and managed by the device to determine whether or not the software update is required. If the update is necessary, the device downloads to the wireless terminal new control software conforming to modifications of the notified version (Japanese Patent Laid-Open Publication No. 2001-78258).

Japanese Patent Laid-Open Publication No. 2001-75786 describes a technique regarding a program file download system in which even when the download of a program file takes quite a long period of time, for example, several days to update programs, the program update can be carried out without affecting ordinary jobs.

According to the technique, when a version update tool on a terminal side recognizes elapse of a schedule kept therein, the tool makes a telephone call to a server to establish communication thereto and then logs in to the server. Thereafter, a version check part obtains a version of a program via a network from a version table storage of the server. If the version of the server is younger than the version of the associated program of the terminal, the version check part notifies the condition to a download part. The download part downloads a program file from the server. The program thus downloaded is not immediately reflected in the terminal, but is once stored in a disk device. Therefore, the program update can be accomplished without being influenced by the ordinary jobs (computer operations).

Additionally, Japanese Patent Laid-Open Publication No. 2003-304254 describes a technique regarding, for example, an open wireless communication system capable of achieving appropriate connection management.

According to the technique, in a wireless LAN system in which an internal terminal to be authenticated by an access point and an external terminal to be authenticated by an authentication server are defined, when communication is conducted by the internal terminal and by the external terminal, the communication of the internal terminal takes precedence. Even when the wireless LAN system is opened to a third party (a user other than the user of the internal terminal), excessive communication capability at the access point can be opened to the third party without adversely influencing the communication of the internal terminal.

### SUMMARY OF THE INVENTION

However, the techniques to update the firmware in the wireless terminal station through wireless communication are attended with problems as below.

First, when the download of firmware is conducted in the wireless LAN system, a basic service set (BSS) area of the access point occupies the wireless line and hence the data communication speed is disadvantageously lowered in the data communication of the user or the data communication of the wireless terminal station during the download.

This is because the carrier sense multiple access with collision avoidance (CSMA/CA) is used as the multiple access method in the wireless RAN system. That is, the download occupies the communication band and hence the overall transmission speed is reduced.

Second, although an originating or transmitting operation during the firmware update of the wireless terminal station is taken into consideration in the conventional methods, disconnection of the wireless line, interruption of operation in the wireless terminal station, and the like are not considered. Therefore, the update methods cannot be necessarily regarded as safe in the wireless RAN system for the following reasons.

In the wireless RAN system, the wireless terminal station often conducts operations to participate in and to leave from the BSS. In addition, the wireless terminal station is powered by a mobile terminal such as a note-type personal computer and a personal digital assistant in many cases. Therefore, there exist many chances in which power of the terminal station is also turned off because the mobile terminal turns power off. As a result, the firmware cannot be completely updated and hence the original firmware cannot be activated.

It is therefore an object of the present invention, which has been devised in consideration of the situation described above, to provide a wireless communication system in which firmware can be downloaded and updated through wireless communication without affecting user's data communication and a firmware update method of a wireless communication terminal station in the wireless communication system.

To achieve the object in accordance with a first aspect of the present invention, there is provided a wireless communication system including a wireless communication base station connected to a backbone network, a wireless communication terminal station for conducting data communication via a wireless line with the wireless communication base station, a mobile terminal in which the wireless communication terminal station is installed, and a download server connected to the backbone network for managing firmware of the wireless communication terminal station. The download server includes a first firmware information transmitting unit for transmitting, when download of firmware is started, firmware information to the wireless communication base station. The wireless communication base station includes a temporary storage unit for temporarily storing in a queue the firmware information transmitted from the download server and a second firmware information transmitting unit for transmitting the firmware information stored in the temporary storage unit to the wireless communication terminal station. The wireless communication terminal station includes first and second recording units for recording firmware therein, a firmware activating unit for activating the firmware recorded in either one of the first and second recording units, and a firmware update unit for replacing the firmware recorded in either one of the first and second recording units with new firmware and thereby updating the firmware.

In accordance with a second aspect the present invention, the wireless communication terminal station includes a reception success notifying unit for issuing, when the firmware information is completely received, a firmware reception success notification to the download server and an update completion notifying unit for issuing, when the firmware information is completely updated, a firmware update completion notification to the download server. The download server includes a reception success history recording unit for recording a reception success history item when the firmware reception success notification is received, an update completion history recording unit for recording an update completion history item when the firmware update completion notification is received, and a failure history recording unit for recording a download failure history item when the download of the firmware fails.

In accordance with a third aspect the present invention, the failure history recording unit includes a second failure history recording unit for recording a download failure history item if the firmware reception success notification is not received even after a predetermined period of time elapses since the download is started, a third failure history recording unit for recording a download failure history item if the firmware update completion notification is not received even after a predetermined period of time elapses since the download is started, and a fourth failure history recording unit for recording a download failure history item when the download failure information sent from the wireless communication terminal station is received.

In accordance with a fourth aspect the present invention, the download server includes a band determining unit for determining, when the download of the firmware is stated, a download band using traffic information of the wireless base station and a band notifying unit for notifying information of the band determined by the band determining unit to the wireless communication base station. The wireless communication base station includes a band controlling unit for executing the second firmware information transmitting unit according to the band information received from the band notifying unit.

In accordance with a fifth aspect the present invention, the wireless communication terminal station includes a version information transmitting unit for transmitting a program version of present firmware to the download server when the wireless communication terminal station belongs to a base service set of the wireless communication base station. The download server includes an update judge unit for determining whether or not the firmware of the wireless communication terminal station is to be updated and an unnecessariness history recording unit for recording a download unnecessariness history item in the download server when the update judge unit determines that the firmware update is unnecessary.

In accordance with a sixth aspect the present invention, the download server includes a start notifying unit for issuing a download start notification to the wireless communication terminal stations belonging to the basic service set of the wireless communication base station and a start time notifying unit for notifying a download start time to the wireless communication base station and each wireless communication terminal station from which a reply is sent to the start notifying unit. The wireless communication base station includes a transmission start control unit for executing the second firmware information transmitting unit at the start time notified from the download server. The wireless communication terminal station includes a firmware information reception waiting unit for restricting the user communication for a predetermined period of time before the start time notified from the download server and waiting for reception of the firmware information.

In accordance with a seventh aspect of the present invention, there is provided a firmware update method for use in a wireless communication terminal station in a wireless communication system including a wireless communication base station and a wireless communication terminal station for conducting data communication via a wireless line with the wireless communication base station. The firmware update method includes a temporary storing step of temporarily storing by the wireless communication base station latest firmware information in a queue, a firmware information transmitting step of transmitting by the wireless communication base station the latest firmware information to the wireless communication terminal station, a record memory determining step of determining, by the wireless communication terminal station, in which one of first and second memories of the wireless communication terminal station the latest firmware information is to be recorded, a firmware recording step of recording the latest firmware by the wireless communication terminal station according to a result of the record memory determining step, and a firmware restarting step of restarting by the wireless communication terminal station the latest firmware information recorded in the firmware recording step.

In accordance with an eighth aspect of the present invention, the firmware update method further includes a band determining step of determining, when download of the latest firmware is stated, a download band using traffic information of the wireless base station and a band control step of executing the firmware transmitting step using the download band determined in the band determining step.

In accordance with a ninth aspect of the present invention, the firmware update method further includes a start notifying step of issuing, when the latest firmware is transmitted, a download start notification to the wireless communication terminal stations belonging to a basic service set of the wireless communication base station, a start time notifying step of notifying a download start time to each wireless communication terminal station from which a reply is received in response to the start notifying step, and a firmware information reception waiting step of restricting by the wireless communication terminal station user communication for a predetermined period of time before the download start time and waiting for execution of the firmware recording step, the execution being effected when the latest firmware information is

In accordance with the present invention, there is provided a wireless communication system including a wireless communication base station connected to a backbone network, a wireless communication terminal station for conducting data communication via a wireless line with the wireless communication base station, a mobile terminal in which the wireless communication terminal station is installed, and a download server connected to the backbone network for managing firmware of the wireless communication terminal station. The download server includes a first firmware information transmitting unit for transmitting, when download of firmware is started, firmware information to the wireless communication base station. The wireless communication base station includes a temporary storage unit for temporarily storing in a queue the firmware information transmitted from the download server and a second firmware information transmitting unit for transmitting the firmware information stored in the temporary storage unit to the wireless communication terminal station. The wireless communication terminal station includes first and second recording units for recording firmware therein, a firmware activating unit for activating the firmware recorded in either one of the first and second recording units, and a firmware update unit for replacing the firmware recorded in either one of the first and second recording units with new firmware and thereby updating the firmware. Therefore, the firmware can be safely updated.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing a configuration of an embodiment of a wireless communication system in accordance with the present invention;

FIG. 2 is a block diagram showing an internal configuration of a wireless communication terminal station;

FIG. 3 is a flowchart showing a firmware download procedure using NWA;

FIG. 4 is a flowchart showing a processing procedure of the wireless communication terminal station in the firmware download; and

FIG. 5 is a flowchart showing a firmware download procedure using FWA.

### DESCRIPTION OF THE EMBODIMENTS

Description will now be given of a first embodiment. This can be called one of the most favorable embodiments because the firmware update is safely conducted and the firmware download is carried out by securing a band dedicated to the download, the band being other than the band for user communication.

Referring next to the drawings, description will be given of embodiments in accordance with the present invention.

First Embodiment

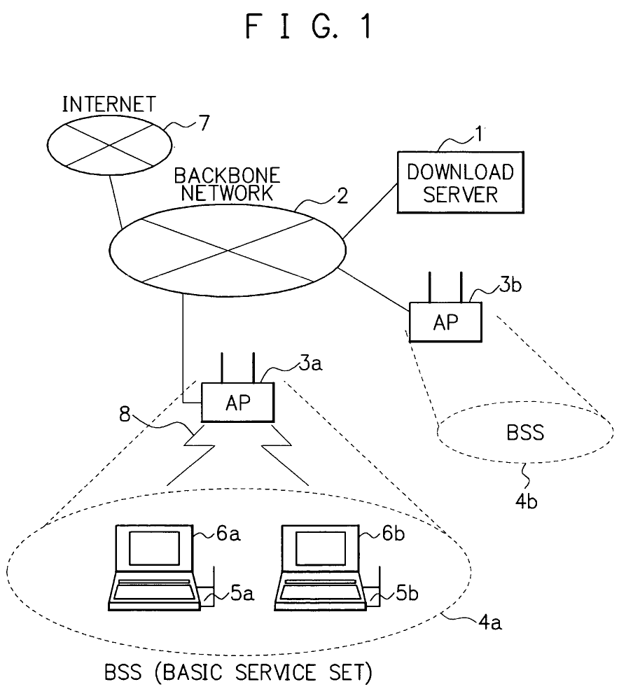

FIG. 1 shows a configuration of an embodiment of a wireless communication system in accordance with the present invention.

Wireless communication terminal stations (to be referred to as “STA” hereinbelow depending on cases) 5a and 5b are installed respectively in mobile terminals 6a and 6b each of which is, for example, a personal computer or a personal digital assistant (PDA).

The terminal station 5 exists in a range of a basic service set (BSS) 4a of an access point (to be referred to as “AP” hereinbelow in some cases). The station 5 is connected via a wireless line 8 to the access point 3a and is linked via a backbone network 2 with the internet 7.

The terminal station 5 has a function to notify an identifier (hardware type information) to uniquely identify a type of the wireless terminal station and information of a present firmware version to a download server 1 (to be referred to as “DS” hereinbelow depending on cases).

Like the access point 3a, an access point 3b controls a basic service set 4b and is connected to the backbone network 2.

The access point 3a obtains communication states and traffic states of the terminal stations 5a and 5b existing in the range of the basic service set 4a and notifies the states to the download server 1. The access point 3a secures on the wireless line 8 a download transmission band determined by the server 1. The server 1 is also coupled with the backbone network 2, and hence an access from the server 1 can be discriminated from an access from the internet 7. In the configuration, it is therefore possible for each of the access points 3a and 3b to restrict a particular access.

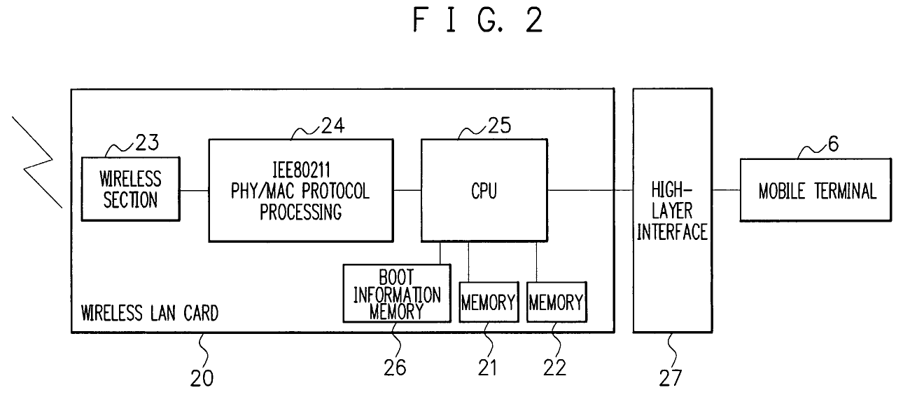

FIG. 2 shows an internal configuration of the wireless communication terminal station. As the terminal station, there can be used, for example, a wireless LAN card 20. FIG. 2 shows an internal configuration of the wireless LAN card 20.

The wireless LAN card 20 as an example of wireless communication terminal station 5 includes a wireless section 23, an IEEE 802.11 PHY/MAC protocol processing section 24, a central processing unit (CPU) 25, memories 21 and 22, and a boot information memory 26.

The wireless section 23 conducts upconvert and downconvert of radio signals.

The protocol processing section 24 processes baseband signals and MAC layer packets.

The CPU 25 executes arithmetic processing and control processing for various types of data.

For example, the CPU 25 controls data conversion processing achieved by an high-layer interface 27. Specifically, in the operation to send data from the wireless LAN card section 20 to the mobile terminal 6, the CPU 25 controls the data conversion for the high layer (high-level layer). Conversely, when the mobile terminal 6 sends data to the wireless LAN card section 20, the CPU 25 controls processing of the data conversion for lower layers (low-level layers).

The CPU 25 also reads and executes a firmware program recorded in the memory 21 or 22.

The CPU 25 refers to the boot information memory 26 and makes a check to determine from which one of the memory 21 or 22 the firmware is to be read. At firmware update, the CPU 25 judges to determine in which one of the memory 21 or 22 the data is to be written.

Either one of the memories 21 and 22 having stored the firmware of the wireless LAN card is used in the configuration to carry out the operation of the wireless LAN card 20.

The wireless section 23, the protocol processing section 24, and the CPU section 25 have a function to obtain firmware information from received wireless signals.

The boot information memory 26 is disposed to store therein selection information to determine which one of the memories 21 is used to obtain a boot therefrom in a program booting operation, information of a present firmware version, and information of a hardware type to uniquely identify the wireless LAN card.

Next, description will be given of operation of the embodiment.

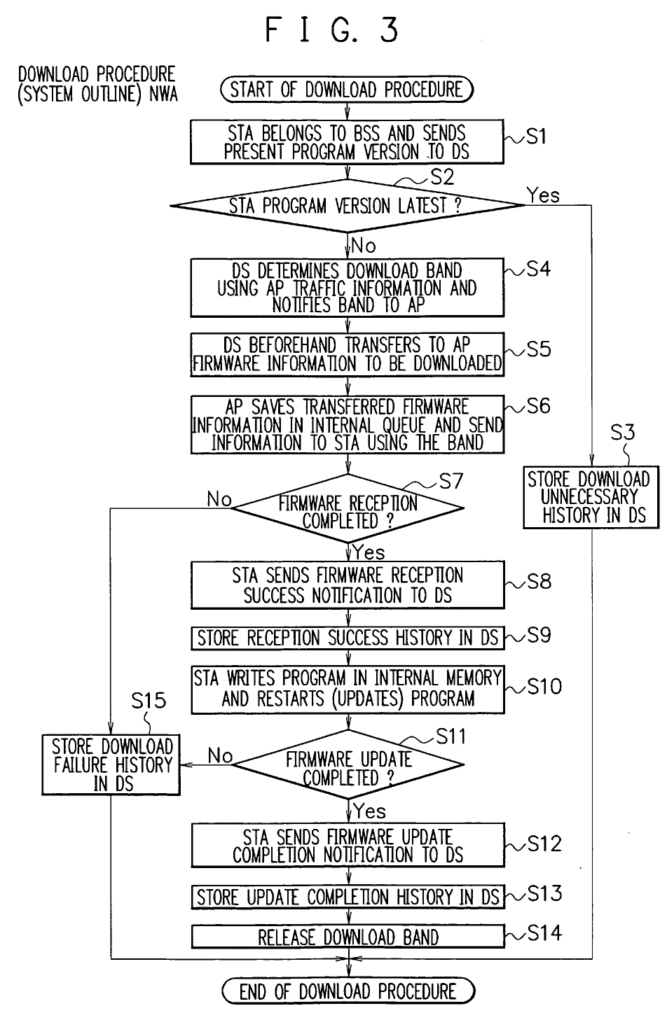

FIG. 3 shows a procedure to download firmware using a nomadic wireless access (NWA).

The wireless terminal station (STA) 5a belongs to the basic service set (BSS) 4a and sends information of a version of present firmware to the download server (DS) together with the hardware type information (step S1).

The download server 1 compares the program version received from the station 5a with a version managed by the server 1 (step S2). If the received version is a latest one (yes in step S2), the server 1 stores therein a download unnecessary history item indicating that the download is not required (step S3) to thereby terminate the download procedure.

If the firmware of the station 5a is not the latest firmware as a result of the comparison (no in step S2), the server 1 acquires traffic information of the access point 3a to which the station 5a belongs. Using the traffic information, the server 1 determines a band for the download, the band not affecting a user data communication band of the station 5a and data communication bands of the wireless terminal stations such as the station 5b belonging to BSS 4a. The server 1 then notifies the download band to the access point 3a (step S4).

The server 1 beforehand transfers to the access point 3a information of the firmware to be downloaded by the station 5a (step S5).

The access point 3a secures the download band, saves the transferred firmware information in an internal queue (or, for example, a buffer memory), not shown, and then transmits the firmware information via the band to the station 5a (step S6). At this point, the terminal station 5a starts downloading of the firmware.

After the firmware download is initiated, the download server 1 enters a state to await reception of a firmware reception success notification from the station 5a indicating the firmware has been successfully received and a firmware update completion notification indicating that the firmware update has been completed in the station 5a.

Since the download communication band and the data size of the firmware information are determined, the server 1 predicts using information thereof a period of time from the firmware download to the firmware update. Even after a period of time obtained by adding a marginal period of time □ to the predicted period of time, i.e., (predicted time+□), if the firmware reception success notification or the firmware update completion notification is not received, that is, if a timeout condition takes place, the server 1 determines that the download has failed.

The timeout occurs in a case in which, for example, the station 5a moves to a position outside the range of BSS 4a and hence the wireless communication becomes impossible, that is, the station 5a does not belong to the BSS 4a. The timeout also occurs in a case in which, for example, power of the mobile terminal 6a in which the station 5a is installed is turned off during the firmware update, and hence the terminal 5a cannot conduct the operation, i.e., cannot update the firmware.

The station 5a receives the firmware (step S7). When the data is completely received (yes in step S7), the station 5a sends a firmware reception success notification to the download server 1 (step S8). The server 1 receives the notification and stores a reception success history item therein (step S9).

The station 5a conducts an operation to write the program in an internal memory and then restarts the processing. That is, the station 5a executes the firmware update processing (step S10).

If the firmware reception success notification is not received even after a predetermined period of time has elapsed and hence a timeout event occurs (no in step S7), the server 1 determines that the download has failed and then stores a download failure history item therein.

When the firmware update processing (step 10) is successfully finished (yes in step S11), the station 5a sends a firmware update completion notification to the server 1 (step S12). Thereafter, the station 5a releases the download band (step S14).

If the firmware update completion notification is not received even after a predetermined period of time has elapsed and hence a timeout event occurs (no in step S11), the server 1 determines that the download (update) has failed and then stores a download failure history item therein.

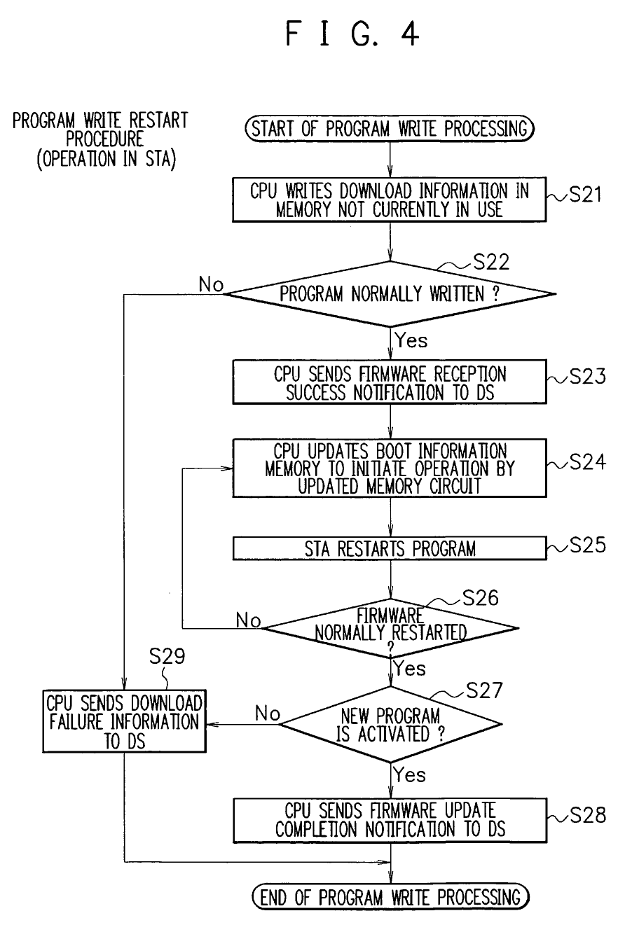

FIG. 4 shows a processing procedure for the wireless communication terminal station to download the firmware.

The CPU section 25 refers to the boot information memory 26 to write the download information, i.e., the latest firmware program in a memory not in use at the point of time (step S21).

It is assumed for convenience of description that the present firmware program has been recorded in the memory 21 and the latest firmware thus downloaded has been stored in the memory 22.

When the firmware program is normally written in the memory (yes in step S22), the CPU section 25 sends a firmware reception success notification to the download server 1 (step S23). To enable the latest firmware in the memory circuit 22 thus updated to achieve its operation, the CPU 25 updates the contents of the boot information memory 26 (step S24), and the station 5 restarts the latest firmware program in the memory 22 (step S25).

The CPU 25 makes a check to determine whether or not the latest firmware has been normally restarted in the memory 22 (step S26). If the restart has failed due to a fault such as incomplete data (no step S26), the CPU 25 prepares the present firmware to start in the memory 21. For this purpose, the CPU 25 rewrites the contents of the boot memory 26 (step S24) and then restarts the current firmware in the memory 21 (step S25). As a result, either one of the old firmware or the new firmware is restarted.

After the firmware is activated (yes in step S26), the CPU 25 makes a check to determine which one of the programs respectively of the memories 21 and 22 is activated (step S27).

If the new firmware program in the memory 22 is activated (yes in step S27), the CPU 25 executes processing to send a firmware update completion notification to the download server 1 (step S28) to thereby terminate the sequence of program writing operations on the wireless terminal station side.

If the firmware program cannot be successfully written in the memory due to a fault (no in step S22) or if the firmware restart is conducted using the present firmware program in the memory 21 (no in step S27), the CPU 25 sends to the server 1 download failure information indicating failure of the program writing or restart operation (step S29) to thereby terminate the sequence of program writing steps on the wireless terminal station side.

In some cases other than the timeout event, the server 1 executes the processing to store download failure history in a situation in which communication is possible between the station and the access point if a fault occurs in the wireless terminal station and the firmware download fails (step S15 of FIG. 3).

As above, in the configuration including two memory circuits, one of the memory circuits is used as a main memory circuit for the data communication and the other one thereof is employed as a subordinate memory circuit for the firmware download and update processing. After the firmware is completely updated, the main memory circuit and the subordinate memory circuit are replaced with each other. Due to the operation, the user's data communication can be conducted without interruption during the update of the firmware.

The present invention has aspects as below.

First, the firmware is downloaded using a band dedicated to the firmware download while securing user's communication bands. Specifically, the wireless base station (AP) secures the download band according to the communication state in the basic service set to download the firmware to the wireless terminal station (STA) using a queue dedicated to the download operation. Therefore, the communication speed of the ordinary data communication is not affected.

As a result, the user can advantageously conduct ordinary data communication without perceiving reduction in the data communication speed.

Second, the wireless terminal station includes two memory circuits and a boot information memory. Concretely, one of the memory circuits stores a program to conduct operation of the present firmware, i.e., to conduct data communication. The other memory circuit is adopted for the firmware download. The boot information memory stores information indicating that which one of the memory circuits is employed to conduct the firmware operation and which one thereof is utilized for the firmware download. The CPU activates the firmware program by referring to the boot information in the memory.

Therefore, even when the CPU fails in starting the firmware program stored in one of the memory circuits, it is possible to activate the program in the other one memory circuit. This consequently leads to an advantage that even if the firmware download fails, the system can be easily restored.

Third, only under a condition that the wireless terminal station participates in a particular basic service set, the firmware update processing can be automatically executed. During the update processing, the user does not perceive the download processing.

This advantageously mitigates the load imposed on the user to install the firmware. This also leads to an advantage that when products of the IEEE 802.11 specifications are released before the formal approval thereof, the contents of standardization can be easily reflected without any particular cost.

Second Embodiment

Subsequently, description will be given of a second embodiment in accordance with the present invention.

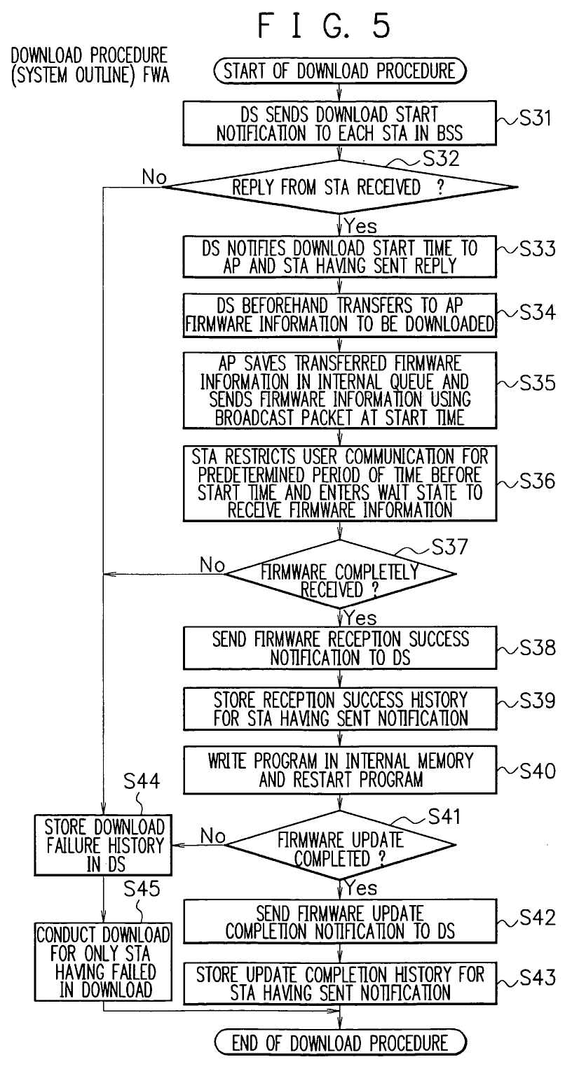

FIG. 5 shows a firmware download procedure using a fixed wireless access (FWA). The configuration of the wireless communication system and the internal configuration of the wireless communication terminal station are similar to those of the first embodiment.

The download server 1 sends a download notification to the wireless terminal stations including the stations 5a and 5b (step S31) and then waits for a reply from each of the stations for a predetermined period of time (step S32).

When one of the stations sends a reply to the download notification within the predetermined period of time and the reply is received (yes in step S32), the server 1 notifies a download start time to the wireless base station (AP) 3 and the wireless terminal station 5 from which the response is received (step S33).

For the wireless terminal stations 5 from which any reply is not received (no in step S32), the server 1 stores a download failure history item therein for each of the stations 5 (step S44).

After having notified the download start time (step S33), the server 1 beforehand transfers to the station (AP) 3 firmware information to be downloaded (step S34). The station 3 saves the transferred firmware information in an internal queue. Thereafter, at the start time, the station 3 sends the firmware information using a broadcast packet (step S35).

The wireless terminal station 5 restricts the user communication for a predetermined period of time before the download start time and enters a wait state to receive the firmware information (step S36).

If the firmware is completely received within the predetermined period of time (yes in step S37), the terminal station 5 sends a firmware reception success notification to the download server 1 (step S38).

If the firmware reception is not completed within the period of time for some reason, for example, occurrence of a timeout event (no in step S37), the server 1 stores a download failure history item therein for the pertinent terminal station 5 (step S44).

When the firmware reception success notification is received, the server 1 stores a reception success history item therein for the terminal station 5 (step S39). The terminal station 5 then writes the firmware program in an internal memory and restarts the program (step S40).

If the firmware update is completed within the predetermined period of time (yes in step S41), the terminal station 5 sends a firmware update completion notification to the server 1 (step S42). The server 1 stores an update completion history item therein for the terminal station 5.

If the firmware is not completely updated within the period of time because of, for example, occurrence of a timeout event (no in step S41), the server 1 stores a download failure history item therein for the terminal station 5 (step S44).

For each wireless terminal station 5 having failed in downloading the firmware, the server 1 stores a download failure history item therein for the terminal station 5 (step S44) and individually downloads the firmware to the terminal station 5 (step S45).

Since operation on the wireless terminal station side is similar to that of the procedure shown in FIG. 4, description thereof will be avoided.

As can be seen from the description, it is expectable that the present invention leads to advantageous effects as below.

First, the wireless communication terminal station includes two memory circuits to record firmware and the firmware recorded in one of the memory circuits is executed. Therefore, the user can conduct wireless data communication also during the firmware update operation. The firmware update is accomplished in the memory circuit other than the memory circuit having recorded the present firmware. Consequently, even if the firmware update fails, the function of the wireless data communication can be kept retained using the current firmware.

Second, the firmware is downloaded by use of a band dedicated to the firmware download while securing the user's data communication bands. Therefore, also during the firmware update operation, the data communication of the user can be carried out at a communication rate not affected by the firmware download.

Third, the firmware update processing is automatically executed when the wireless communication terminal station belongs to a basic service set of an access point or when the download server sends a download start indication. In consequence, it is not required for the user to conduct the firmware update operation.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A wireless communication system, comprising:
a wireless communication base station connected to a backbone network;
a wireless communication terminal station for conducting data communication via a wireless line with the wireless communication base station;
a mobile terminal in which the wireless communication terminal station is installed; and
a download server connected to the backbone network for managing firmware of the wireless communication terminal station,
the download server including first firmware information transmitting means for transmitting, when download of firmware is started, firmware information to the wireless communication base station,
the wireless communication base station including temporary storage means for temporarily storing in a queue the firmware information transmitted from the download server and
second firmware information transmitting means for transmitting the firmware information stored in the temporary storage means to the wireless communication terminal station,
the wireless communication terminal station including first and second recording means for recording firmware therein,
firmware activating means for activating the firmware recorded in either one of the first and second recording means, and
firmware update means for replacing the firmware recorded in either one of the first and second recording means with new firmware and thereby updating the firmware.

2. A wireless communication system in accordance with claim 1, wherein:
the wireless communication terminal station includes reception success notifying means for issuing, when the firmware information is completely received, a firmware reception success notification to the download server and
update completion notifying means for issuing, when the firmware information is completely updated, a firmware update completion notification to the download server; and
the download server includes reception success history recording means for recording a reception success history item when the firmware reception success notification is received,
update completion history recording means for recording an update completion history item when the firmware update completion notification is received, and
failure history recording means for recording a download failure history item when the download of the firmware fails.

3. A wireless communication system in accordance with claim 2, wherein:
the failure history recording means includes second failure history recording means for recording a download failure history item if the firmware reception success notification is not received even after a predetermined period of time elapses since the download is started,
third failure history recording means for recording a download failure history item if the firmware update completion notification is not received even after a predetermined period of time elapses since the download is started, and
fourth failure history recording means for recording a download failure history item when the download failure information sent from the wireless communication terminal station is received.

4. A wireless communication system in accordance with one of claims 1 to 3, wherein:
the download server includes band determining means for determining, when the download of the firmware is stated, a download band using traffic information of the wireless base station and
band notifying means for notifying information of the band determined by the band determining means to the wireless communication base station; and
the wireless communication base station includes band controlling means for executing the second firmware information transmitting means according to the band information received from the band notifying means.

5. A wireless communication system in accordance with claim 4, wherein:
the wireless communication terminal station includes version information transmitting means for transmitting a program version of present firmware to the download server when the wireless communication terminal station belongs to a base service set of the wireless communication base station;
the download server includes update judge means for determining whether or not the firmware of the wireless communication terminal station is to be updated and
unnecessariness history recording means for recording a download unnecessariness history item in the download server when the update judge means determines that the firmware update is unnecessary.

6. A wireless communication system in accordance with one of claims 1 to 3, wherein:
the download server includes start notifying means for issuing a download start notification to the wireless communication terminal stations belonging to the basic service set of the wireless communication base station and
start time notifying means for notifying a download start time to the wireless communication base station and each wireless communication terminal station from which a reply is sent to the start notifying means;
the wireless communication base station includes transmission start control means for executing the second firmware information transmitting means at the start time notified from the download server; and
the wireless communication terminal station includes firmware information reception waiting means for restricting the user communication for a predetermined period of time before the start time notified from the download server and waiting for reception of the firmware information.

7. A firmware update method for use in a wireless communication terminal station in a wireless communication system including a wireless communication base station and a wireless communication terminal station for conducting data communication via a wireless line with the wireless communication base station, comprising:
a temporary storing step of temporarily storing by the wireless communication base station latest firmware information in a queue;
a firmware information transmitting step of transmitting by the wireless communication base station the latest firmware information to the wireless communication terminal station;
a record memory determining step of determining, by the wireless communication terminal station, in which one of first and second memories of the wireless communication terminal station the latest firmware information is to be recorded;
a firmware recording step of recording the latest firmware by the wireless communication terminal station according to a result of the record memory determining step; and
a firmware restarting step of restarting by the wireless communication terminal station the latest firmware information recorded in the firmware recording step.

8. A firmware update method in accordance with claim 7, further comprising:
a band determining step of determining, when download of the latest firmware is stated, a download band using traffic information of the wireless base station and
a band control step of executing the firmware transmitting step using the download band determined in the band determining step.

9. A firmware update method in accordance with claim 7, further comprising:
a start notifying step of issuing, when the latest firmware is transmitted, a download start notification to the wireless communication terminal stations belonging to a basic service set of the wireless communication base station;
a start time notifying step of notifying a download start time to each wireless communication terminal station from which a reply is received in response to the start notifying step; and
a firmware information reception waiting step of restricting by the wireless communication terminal station user communication for a predetermined period of time before the download start time and waiting for execution of the firmware recording step, the execution being effected when the latest firmware information is received.
